(19) United States
(12) Patent Application Publication
(10) Pub. No.: US 2012/0286721 A1
(43) Pub. Date: Nov. 15, 2012

(54) Multi-purpose Mobile Power Supply Charger Structure

(76) Inventor: TSAI SHIN MOU, Taipei (TW)

(21) Appl. No.: 13/105,880

(22) Filed: May 11, 2011

(51) Int. Cl. H02J 7/00

(52) U.S. Cl. 320/107

(57) ABSTRACT

A multi-purpose mobile power supply charger structure comprising: a main body, with containing room, and sequentially comprising stepladder shaped an upper, a middle, and a lower frame, inside of the main body, provided with a battery and a circuit device, and on both sides of the main body provided with an output port and an input port, and on the back side of the main body further provided with a movable plug, and at the lower fringe of the upper frame provided with a sliding groove, and on the middle frame, provided groove through connection point, which electrically connected with the circuit device, as to the lower frame, provided with a slide guiding groove and a recovery mechanism; a power switch, provided on the upper frame and connected with the built-in battery and the circuit device; a detecting switch, provided on the upper frame, and connected with its one side provided with indicating lights; a plurality of fastening block, provided in the sliding groove of the upper frame, wherein at least two of the fastening block, and provided with a projecting through connection point; a rotatable top plate, provided with a restraining block, and provided on the lower frame with a rotation axle, and connected with the recovery mechanism. Thereby, with this design, the present invention provides charging to batteries of various kind of portable electronic product and support to its operation power, and further provides charging with built-in battery of its main body.

The purpose of the present invention is to provide a multi-purpose mobile power supply charger structure comprising:
a main body, being a shell body with containing room, and sequentially comprising stepladder shaped an upper frame, a middle frame, and a lower frame, inside of the main body, provided with a built-in battery and thereby connected a circuit device, and on both sides of the main body provided with an output port and an input port, and on the back side of the main body further provided with a movable plug, and at the lower fringe of the upper frame provided with a sliding groove being connected with the middle frame, and on the middle frame, provided groove with at least two projecting through connection point, which electrically connected with the circuit device, as to the lower frame, provided with a slide guiding groove with a recovery mechanism;
a power switch, provided on the upper frame and connected with the built-in battery and the circuit device;
a detecting switch, provided on the upper frame, and connected with its one side provided with a plurality of indicating lights, said detecting switch being electrically connected with the built-in battery and the circuit device;
a plurality of fastening block, provided in the sliding groove of the upper frame, wherein at least two of the fastening block facing an end of the middle frame, and provided with a projecting through connection point with automatic polarity detection and connected to the circuit device;
a rotatable top plate, provided on the lower frame with a rotation axle set in the middle, and said rotation axle 22 is set corresponding to the slide guiding groove of the lower frame and connected with the recovery mechanism, and a restraining block provided on the rotatable top plate.

Preferably, said indicating lights can be a LED.

Preferably, said output port of the main body can be an USB socket.

Preferably, said USB socket provides power of 5V/1000 mAh.

Preferably, said input port of the main body can be a Micro USB socket.

Preferably, said Micro USB socket provides power of 5V/500 mAh.

Further, said fastening block provided with a projecting portion projecting out of the upper frame from the sliding groove.

with this design, the present invention provides charging to batteries of various kind of portable electronic product and support to its operation power, and further provides charging with built-in battery of its main body, effectively enhance its convenience to use, complies with novelty, non-obviousness, and applicability, so the benefit is obvious.

### DETAILED DESCRIPTION OF THE PREFERRED EMBODIMENTS

For better understanding of the characteristics, contents and effect of the present invention to the examiners, through the following preferred embodiments, together with attached drawings, a detailed description is presented as following. Note that the drawings applied is for being schematic and as an auxiliary in explanation purpose, so not necessary to match the real size of practical configuration, and the size ratio therein is not to limit the range of the present invention.

With reference to FIG. 1, 2, 3, 4, the drawings shown are, a perspective view of the pull-down rotatable top plate, a perspective view of the assembling, and a plan view of the present invention. A preferred Embodiment of a multi-purpose mobile power supply charger structure of the present invention is comprised of a main body 1, a power switch 11, a detecting switch 12, a plurality of fastening block 14, a rotatable top plate 2.

Wherein, said main body 1 is a shell body with containing room, and sequentially comprising stepladder shaped an upper frame 100, a middle frame 200, and a lower frame 300, that is the upper frame 100 is adjacent above the middle frame 200, and the middle frame 200 is above the lower frame 300, and for providing mobile power source and power for charging, inside of the main body 1, is provided with a built-in battery 2000 and thereby connected a circuit device 18, wherein said built-in battery 2000 provides power source of 5V/1000 mAh, and said circuit device 18 is mainly comprised of an AC/DC rectifying charger circuit, an over-charge protective deenergizing circuit, and a polarity shift detecting circuit, further, on both sides of the main body 1 of the present invention are provided with an output port 15 and a input port 16, which are electrically connected with the built-in battery 2000 and the circuit device 18, and on the back side of the main body 1 further provided with a movable plug 17, wherein, the output port 15 can be a USB socket, and said USB socket provides power of 5V/1000 mAh, as to the movable plug 17, is an US standard bi-pin plug with standing electric voltage and current of 100-240V/100 mAh, but not as a limitation to the present invention, can further be a tri-pin plug, or any amount of pin plug, and in accordance with usage needs, any shape of socket, plug and any kind of electric voltage, current, power shall belong to the range of protection of the present invention, and at the lower fringe of the upper frame 100 provided with a sliding groove 13 being connected with the middle frame 200, and on the middle frame 200, provided with at least two slidably projecting through connection point 202 (conductive metal point), which electrically connected with the circuit device 18, as to the lower frame 300, provided with an up erecting slide guiding groove 301 with a recovery mechanism 302 provided in the main body 1, said recovery mechanism 302 being a spring for producing the recovery energy source.

Said power switch 11 is provided on the upper frame 100 of the main body 1 and connected with the built-in battery 2000 and the circuit device 18, thereby providing on and off of the power source.

Said detecting switch 12 is provided on the upper frame 100, and connected with its one side provided with a plurality of indicating lights 121, said detecting switch 12 being electrically connected with the built-in battery 2000 and the circuit device 18, the plurality of indicating lights 121 of the present embodiment can be a LED (light emitting diode), but not as a limitation to the present invention, it can also be various kind of luminous light emitting component, all belong to the range of protection of the present invention, by pressing the detecting switch 12, the power of the built-in battery 2000 can be detected, by the value of internal impedance of said built-in battery 2000, thereby the amount of luminary indicating lights 121 can be determined, the more power the more LED indicating lights 121 are luminated otherwise the less.

Above mentioned fastening block 14 are provided in the sliding groove 13 of upper frame 100, wherein at least two of the fastening block 14 are facing an end of the middle frame 200, and provided with a projecting through connection point 141 (conductive metal point) with automatic polarity detection and connected to the circuit device 28, on the fastening block 14 projecting out from the sliding groove 13, further provided with a projecting portion 140, so that the fastening block 14 can be easily moved with fingers.

Above mentioned rotatable top plate 2 is provided on the lower frame 300 of the main body 1, with a rotation axle 22 set in the middle for rotating to its right or left, and said rotation axle 22 is set corresponding to the slide guiding groove 301 of the lower frame 300 and connected with the recovery mechanism 302, that is, the rotatable top plate 2 is set to be up-down sliding movable for adjusting its position, and the recovery mechanism 302 served to recover pulled down rotatable top plate 2 and butt contacted with the upper end of the lower frame 300, and on the surface of the rotatable top plate 2, horizontally set a restraining block 21, in the present embodiment the restraining block 21 shown is reverse U-shaped, however that is not to be a limitation to the present invention, that shape can be various kind of shape, all belong to the protection range of the present invention, so further provides easier pulling up-down of the rotatable top plate 2.

With reference to FIG. 4, 5,6, 7, the drawings shown are, a plan view showing the adjusting operation of the rotatable top plate, and function diagrams 1, 2, 3 of right turning 360° of the rotatable top plate of the present invention, for convenient of showing the adjustment of longer or shorter gap between the restraining block 21 and lower end of the middle frame 200, the present embodiment shows the shrinking gap adjustment, start the operation with pulling down the rotatable top plate 2 toward lower end of the bottom frame 300 (as shown in FIG. 4), then right turn 360° of the rotatable top plate 2 (as shown in FIG. 5), this direction is easier for right handed person, then the rotatable top plate 2 is pulled back toward the middle frame 200 by the strength produced from the recovery mechanism 302 (as shown in FIG. 6), until butt contacted and automatically set in position (as shown in FIG. 7).

With reference to FIG. 8, 9, 10, the drawings shown, are the function diagram 1, 2, 3 of left turning 360° of the rotatable top plate of the present invention, as shown in FIG. 8, the gap between the rotatable top plate 2 and lower end of the middle frame 200 is adjusted the same as in FIG. 3, in addition to the direction easier for right handed person, it can also made easier for left handed person, that is after pulling down the rotatable top plate 2 (as shown in FIG. 8), then left turning 360° of the rotatable top plate 2 (as shown in FIG. 9), then the rotatable top plate 2 is pulled back toward the middle frame 200 by the strength produced from the recovery mechanism 302 (as shown in FIG. 10), until butt contacted and automatically set in position (as shown in FIG. 3), while said restraining block 21 of the rotatable top plate 2 will be further away from lower end of the middle frame 200.

With reference to FIG. 11, 12, 13, 14, the drawings shown are, an exploded perspective view of an embodiment of connecting a battery with the present invention, a perspective view of an embodiment of assembling a battery with the present invention, a sectional view of FIG. 12 of the present invention, a perspective view of an embodiment of assembling another battery with the present invention, this embodiment provided with a battery 3 with a conductive flake 31 on a side of its end surface, said conductive flake 31 works with the through connection point 202 of the fastening block 14 of the upper frame 100, for matching the size of said battery 3, just need to adjust the rotatable top plate 2 so that the gap slightly less than battery size, and through the recovery mechanism 302 in the main body 1, said battery 3 will be pushed by the restraining block 21 to contact with the movable fastening block 14 of the upper frame, and because at least two of the fastening block 14 are provided with through connection point 202 (conductive metal point), therefore the conductive flake 31 of the battery 3 can be contacted with the connection point 202 of the fastening block 14, thus charging battery with rectified commercial power can be applied. In the case of the size of the battery 3 is less than the gap as shown in FIG. 3 (i.e. the gap between the lower end of upper frame 100 and the restraining block 21 of the rotatable top plate 2), then the conductive flake 31 of the battery 3 can not be contacted with the connection point 202 of the fastening block 14, simply pull down and rotate the rotatable top plate 2 until the situation reached as shown in FIG. 7, after adjusted the gap between the restraining block 21 and the lower end of the upper frame 100 become less than the battery 3, when the battery 3 placed in between, will be pushed by the restraining block 21 and the recovery mechanism 302 of the main body 1, thus the projecting through connection point 202 of the fastening block 14 can be contacted with the conductive flake 31 of the battery 3, and the purpose of charging the battery can be reached (as shown in FIG. 14), as to the fastening block 14 without a through connection point 202, can be restrained to both sides of the battery 3, providing stability and balance to the battery 3.

With reference to FIG. 15, 16, 17, the drawings shown are, a perspective view of another embodiment of assembling a battery with the present invention, a perspective view of another embodiment of assembling a battery with the present invention, a sectional view of FIG. 16 of the present invention, that is the conductive flake 31 of the battery 3 is located on the bottom side of the battery 3 (like a SAMSUNG battery), thus the conductive flake 31 can not be contacted with the projecting through connection point 202 of the fastening block 14, however, in the present invention, on the groove 201 of the middle frame is provided with at least two projecting and slide movable through connection point 202, therefore the conductive flake 31 of the battery 3 on the bottom side of the battery 3 can be contacted with the connection point 202 and charging purpose can be reached, and the operation of adjusting the gap with rotating the restraining block 21 and the rotatable top plate 2 are as shown in above mentioned FIGS. 5 and 9.

With reference to FIG. 18 of the drawings, a perspective view of assembling a battery with the present invention and providing power supply to a portable electronic product showing, in addition to providing charging capability to the battery 3 with different conductive flake 31 position, but also provided with an output port 15 for Micro USB plug and an input port 16 for USB socket on both sides, that is provided with power input and output, further provides capability of directly charging to the battery 3 and the built-in battery 2000, and 95% of external (lithium)) or other kind of battery 3 of various maker's mobile phone, digital camera, or digital video recorder can be directly charged, further, the present invention support above 90% 5V charging voltage portable electronic product 4, such as mobile phone, smartphone, PDA, MP3, PSP, NDS, GPS, digital camera, blue tooth ear piece, IPHONE, IPOD . . . ETC, and through the male plug 41 connecting to USB socket input port 16, the commercial power can be applied for charging, or when the commercial power not available, through built-in battery 2000, mobile power source can be provided.

Thereby, with this design, the present invention provides charging to batteries of various kind of portable electronic product and support to its operation power, and further provides charging with built-in battery of its main body, effectively enhance its convenience to use, complies with novelty, non-obviousness, and applicability, so the benefit is obvious.

In light of above described, the present invention has made a breakthrough with the prior arts, practically reaches the effect aimed at, and not to be easily thought of by those skilled in the art, further, the present invention has not yet been published before this application, its novelty, applicability, apparently matches with the requirements for applying a patent, thus, submitting this application following the rules, the granting of a patent will be a great encourage to further endeavor to invention and will be highly appreciated.

### BRIEF DESCRIPTION OF THE DRAWINGS

FIG. 1 is a perspective view of the pull-down rotatable top plate of the present invention;

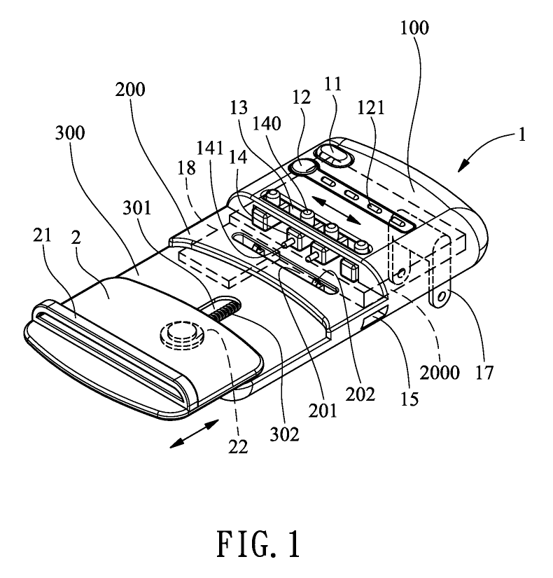

FIG. 2 is a perspective view of the assembling of the present invention;

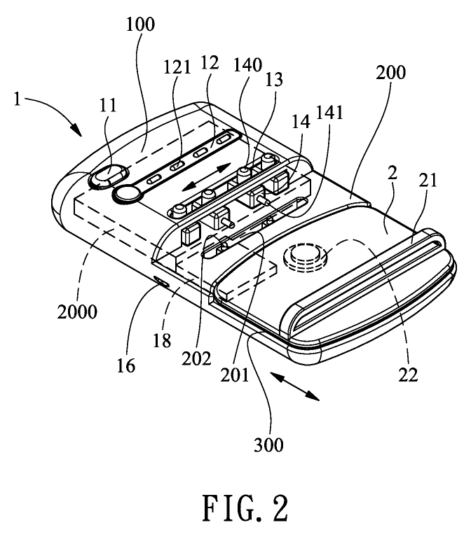

FIG. 3 is a plan view of the present invention;

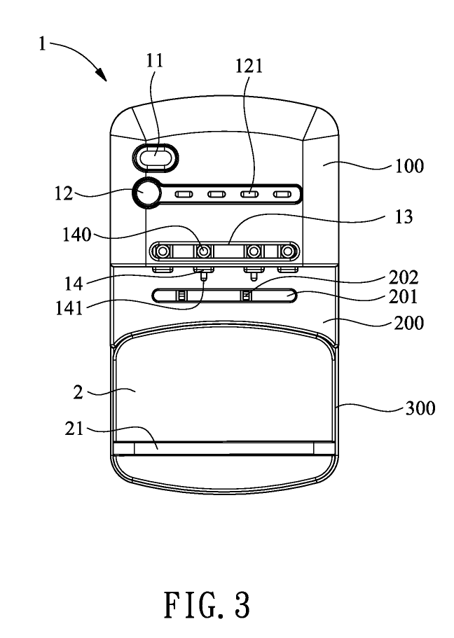

FIG. 4 is a plan view showing the adjusting operation of the rotatable top plate of the present invention;

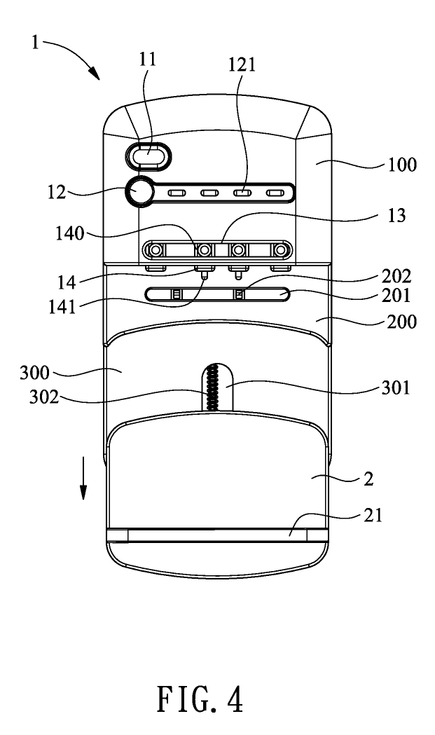

FIG. 5 is a function diagram 1 of right turning 360° of the rotatable top plate of the present invention;

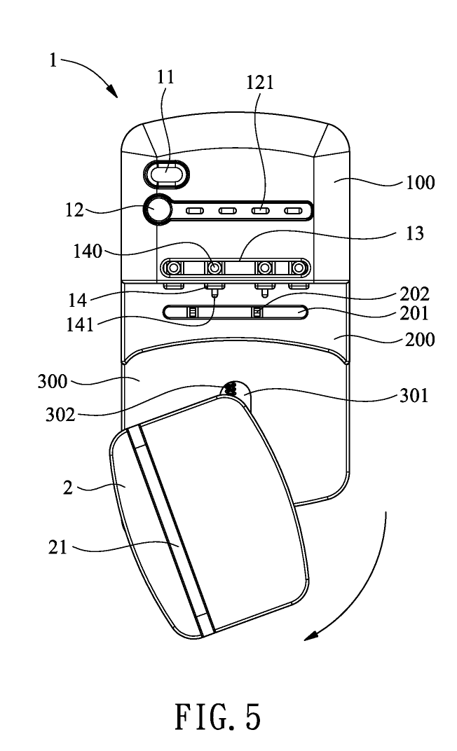

FIG. 6 is a function diagram 2 of right turning 360° of the rotatable top plate of the present invention;

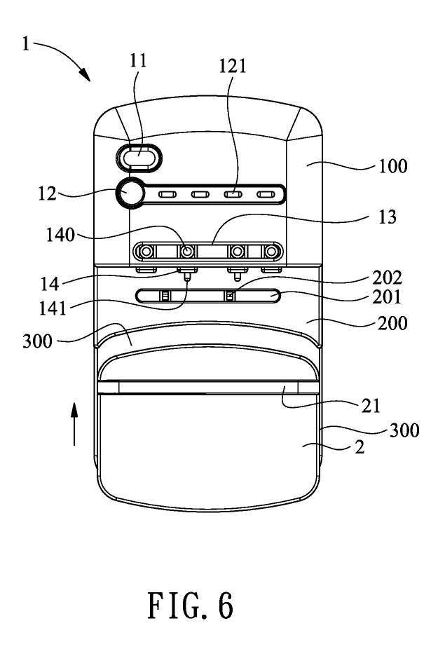

FIG. 7 is a function diagram 3 of right turning 360° of the rotatable top plate of the present invention;

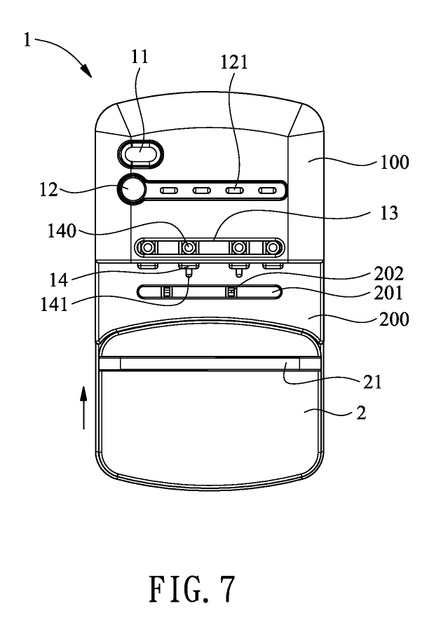

FIG. 8 is a function diagram 1 of left turning 360° of the rotatable top plate of the present invention;

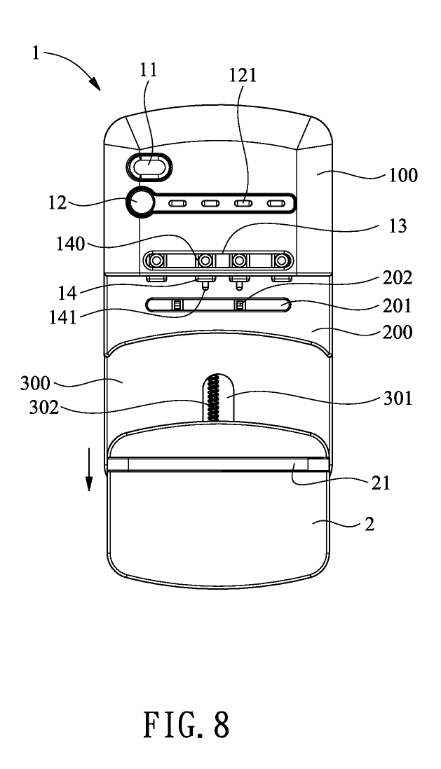

FIG. 9 is a function diagram 2 of left turning 360° of the rotatable top plate of the present invention;

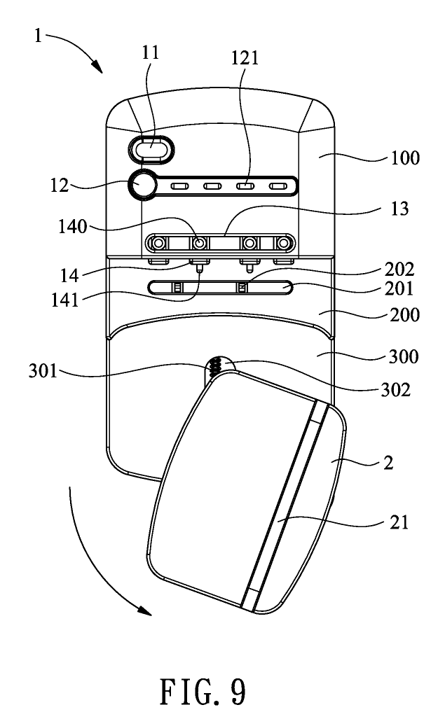

FIG. 10 is a function diagram 3 of left turning 360° of the rotatable top plate of the present invention;

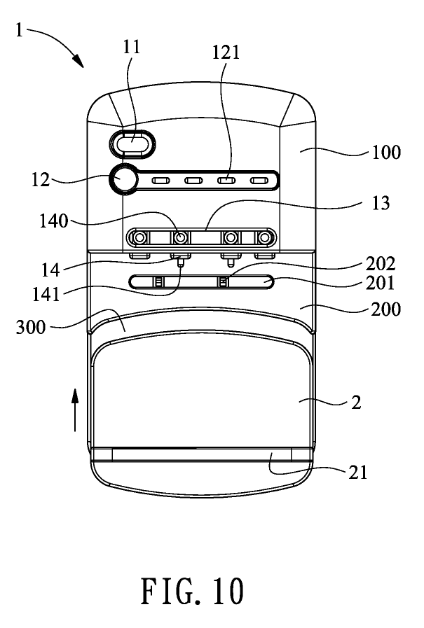

FIG. 11 is an exploded perspective view of an embodiment of connecting a battery with the present invention;

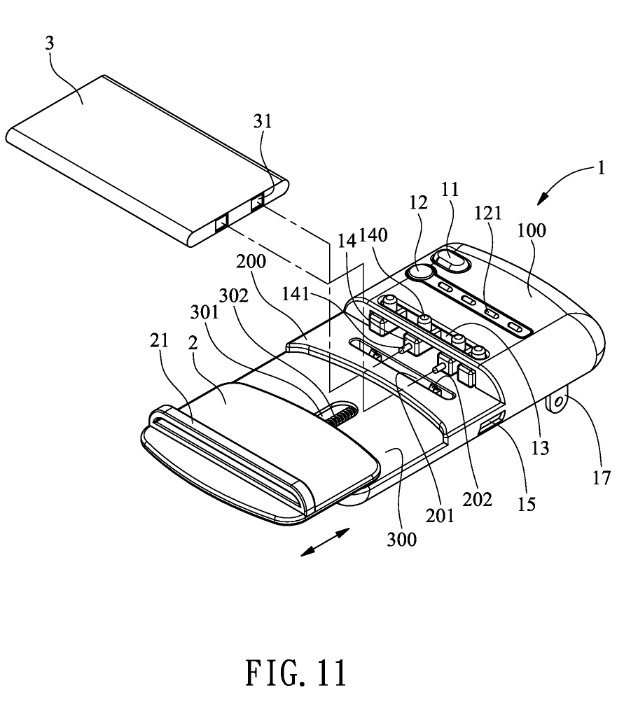

FIG. 12 is a perspective view of an embodiment of assembling a battery with the present invention;

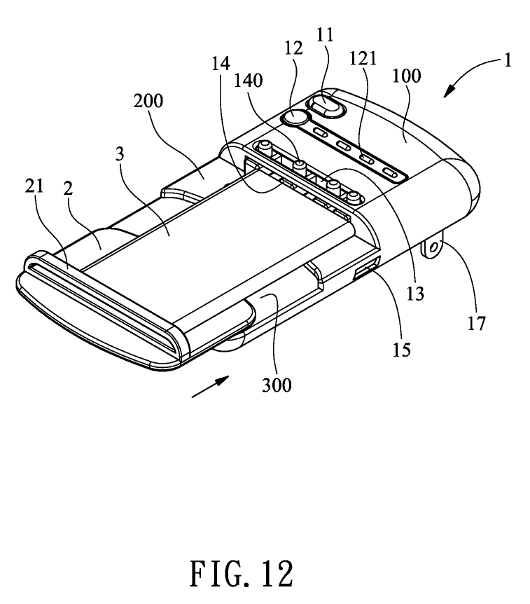

FIG. 13 is a sectional view of FIG. 12 of the present invention;

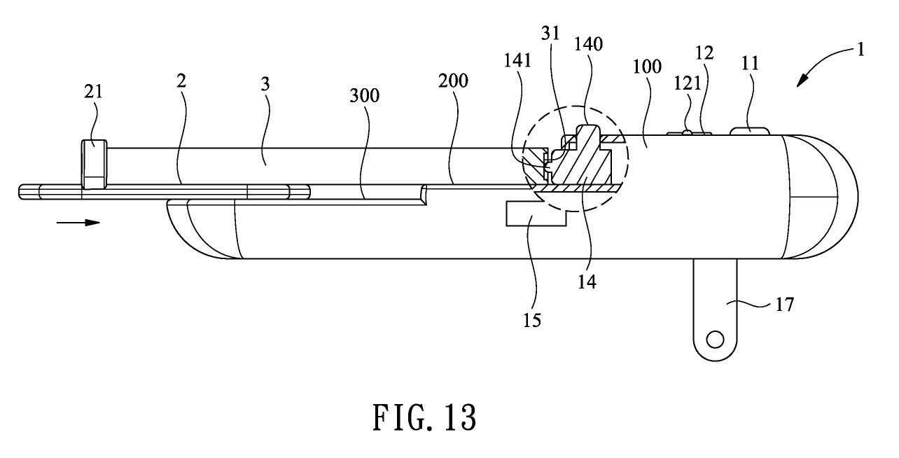

FIG. 14 is a perspective view of an embodiment of assembling another battery with the present invention;

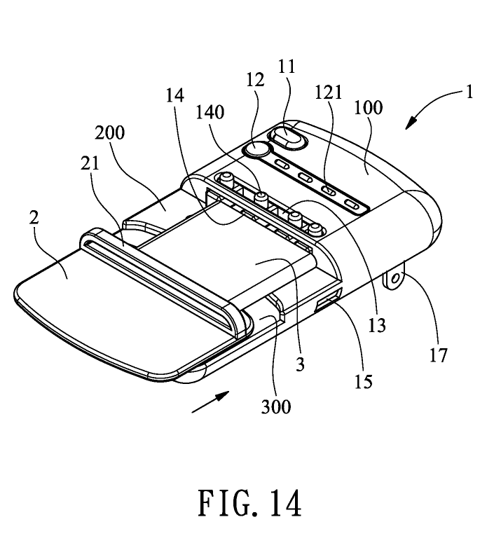

FIG. 15 is a perspective view of another embodiment of assembling a battery with the present invention;

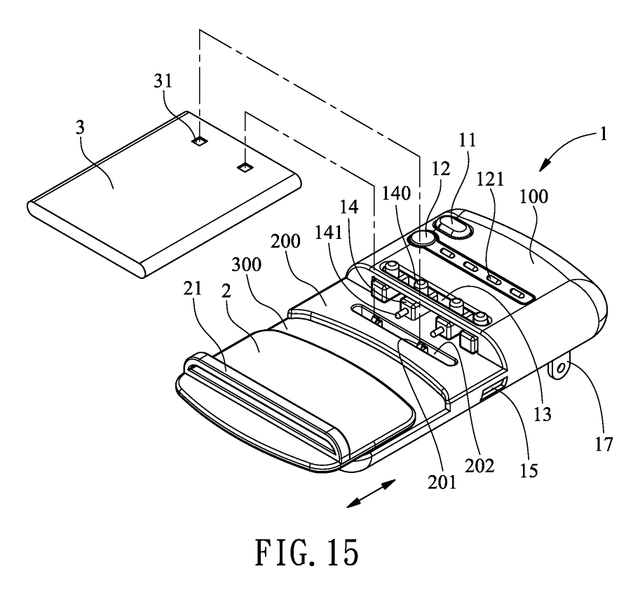

FIG. 16 is a perspective view of another embodiment of assembling a battery with the present invention;

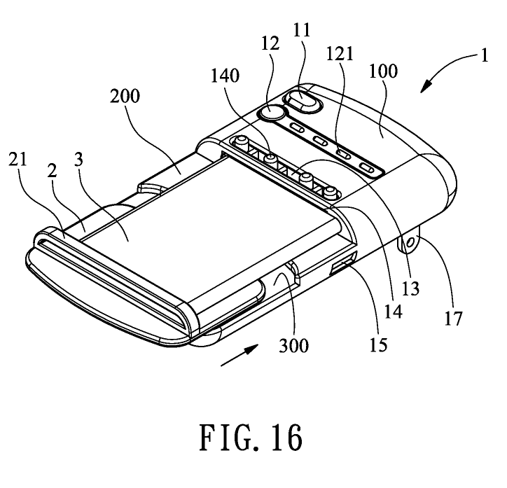

FIG. 17 is a sectional view of FIG. 16 of the present invention;

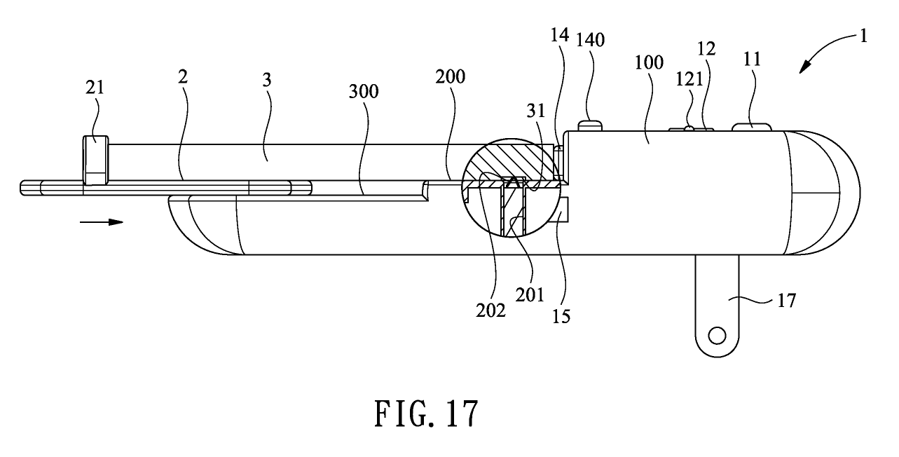

FIG. 18 is a perspective view of assembling a battery with the present invention and providing power supply to a portable electronic product.

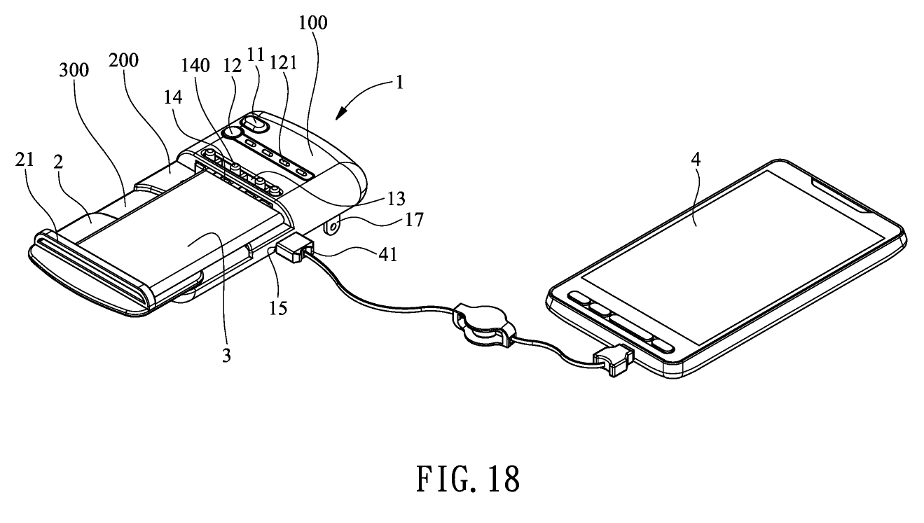

### LEGEND OF MAIN COMPONENTS AND SYMBOLS

1 main body
11 power switch
12 detecting switch
121 indicating lights
13 sliding groove
14 fastening block
140 projecting portion
141 through connection point
15 output port
16 input port
17 movable plug
18 circuit device
100 upper frame
2000 built-in battery
200 middle frame
201 groove
202 through connection point
300 lower frame
301 slide guiding groove
302 recovery mechanism
2 rotatable top plate
21 restraining block
22 rotation axle
3 battery
31 conductive flake
4 portable electronic product
41 USB male connector

What is claimed is:

1. A multi-purpose mobile power supply charger structure comprising:
a main body, being a shell body with containing room, and sequentially comprising stepladder shaped an upper frame, a middle frame, and a lower frame, inside of the main body, provided with a built-in battery and thereby connected a circuit device, and on both sides of the main body provided with an output port and an input port, and on the back side of the main body further provided with a movable plug, and at the lower fringe of the upper frame provided with a sliding groove being connected with the middle frame, and on the middle frame, provided groove with at least two projecting through connection point, which electrically connected with the circuit device, as to the lower frame, provided with a slide guiding groove with a recovery mechanism;
a power switch, provided on the upper frame and connected with the built-in battery and the circuit device;
a detecting switch, provided on the upper frame, and connected with its one side provided with a plurality of indicating lights, said detecting switch being electrically connected with the built-in battery and the circuit device;
a plurality of fastening block, provided in the sliding groove of the upper frame, wherein at least two of the fastening block facing an end of the middle frame, and provided with a projecting through connection point with automatic polarity detection and connected to the circuit device;
a rotatable top plate, provided on the lower frame with a rotation axle set in the middle, and said rotation axle 22 is set corresponding to the slide guiding groove of the lower frame and connected with the recovery mechanism, and a restraining block provided on the rotatable top plate.

2. A multi-purpose mobile power supply charger structure as recited in claim 1 wherein said indicating lights can be a LED light emitting diodes.

3. A multi-purpose mobile power supply charger structure as recited in claim 1 wherein said fastening block provided with a projecting portion projecting out of the upper frame from the sliding groove.

4. A multi-purpose mobile power supply charger structure as recited in claim 1 wherein said output port of the main body can be an USB socket.

5. A multi-purpose mobile power supply charger structure as recited in claim 2 wherein said output port of the main body can be an USB socket.

6. A multi-purpose mobile power supply charger structure as recited in claim 3 wherein said output port of the main body can be an USB socket.

7. A multi-purpose mobile power supply charger structure as recited in claim 4 wherein said USB socket provides power of 5V/1000 mAh.

8. A multi-purpose mobile power supply charger structure as recited in claim 5 wherein said USB socket provides power of 5V/1000 mAh.

9. A multi-purpose mobile power supply charger structure as recited in claim 6 wherein said USB socket provides power of 5V/1000 mAh.

10. A multi-purpose mobile power supply charger structure as recited in claim 1 wherein said input port of the main body can be a Micro USB socket.

11. A multi-purpose mobile power supply charger structure as recited in claim 2 wherein said input port of the main body can be a Micro USB socket.

12. A multi-purpose mobile power supply charger structure as recited in claim 3 wherein said input port of the main body can be a Micro USB socket.

13. A multi-purpose mobile power supply charger structure as recited in claim 10 wherein said Micro USB socket provides power of 5V/500 mAh.

14. A multi-purpose mobile power supply charger structure as recited in claim 11 wherein said Micro USB socket provides power of 5V/500 mAh.

15. A multi-purpose mobile power supply charger structure as recited in claim 12 wherein said Micro USB socket provides power of 5V/500 mAh.
